(19) United States
(12) Patent Application Publication
(10) Pub. No.: US 2010/0071928 A1
(43) Pub. Date: Mar. 25, 2010

(54) RADIATION CURABLE RESIN COMPOSITIONS FOR ELECTRIC WIRE COATINGS

(76) Inventors: Hiroshi Yamaguchi, Tokyo (JP); Satoshi Kamo, Tokyo (JP); Takahiko Kurosawa, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/594,021

(22) PCT Filed: Mar. 28, 2008
(86) PCT No.: PCT/NL08/50177

§ 371 Date: Nov. 23, 2009

(30) Foreign Application Priority Data
Mar. 30, 2007 (JP) 2007-093391
Mar. 30, 2007 (JP) 2007-093393
Mar. 5, 2008 (JP) 2008-054616

(51) Int. Cl. H01B 3/30; C08G 18/32; C08G 77/04; B05D 3/06

(52) U.S. Cl. 174/110 SR; 528/65; 528/28; 427/487

(57) ABSTRACT

The present invention is a radiation curable resin composition comprising: (A) a urethane (meth) aerylate which is a reaction product of a polyol, a polyisocyanate, and a hydroxyl group-containing (meth) aerylate; (B) a compound having a cyclic structure and one ethylenically unsaturated group; (C) from about 0 to about 5 mass % of a compound having two or more ethylenically unsaturated group; and (D) a polyol having a number average molecular weight of about 1500 or more. In another embodiment of the invention component (A) must include a polyester polyol and the polyol of component (D) must have a number average molecular weight of from about 500 to about 1500. The composition is useful for coating electric wire.

### FIELD OF THE INVENTION

The present invention relates to a radiation curable resin composition for coating an electric wire. These coated electric wires have utility in such applications as telephone cables, wires connecting electronic instruments, and wires provided in an electronic instrument.

### BACKGROUND OF THE INVENTION

An electric wire, a telephone cable, a wire connecting electronic instruments, an electric wire provided in an electronic instrument, an automotive electric wire, and the like are generally formed using polyethylene (PE) exhibiting excellent electrical and transmission properties as an insulator and using PE or polyvinyl chloride (PVC) to provide an outer sheath. A television lead wire is coated with PE, or rubber is used as an outer sheath. PVC, polyethylene terephthalate also spelled polyethylene terephtalate (PET), crosslinked PE, and the like are widely used to coat automotive electric wire. See patent documents JP-A-2001-312925, JP-A-2005-187595, JP-A-2006-348137 and JP-A-2007-45952.

A problem has been identified with current electric wire coating. This problem developed because it was desired to have the electric wire coating material possess high strength. When the electric wire coating material possesses high strength then it has good utility as a protective material. However, the high strength of the electric wire coating can interfere with the wiring workability (i.e., peelability of coating layer) of the coated wire. Peelability is not a problem when the electric wire itself is thick. Peelability is a problem when the electric wire itself is thin, because it is difficult to install a thin electric wire used for minute wiring if peelability is poor.

Therefore, it would be desirable to provide an electric wire-coating resin composition and an electric wire coating material which shows good peelability while ensuring sufficient strength.

### SUMMARY OF THE INVENTION

One aspect of the instant claimed invention is a radiation curable resin composition comprising:

(A) a urethane (meth)acrylate which is a reaction product of a polyol, a polyisocyanate, and a hydroxyl group-containing (meth)acrylate;
(B) a compound having a cyclic structure and one ethylenically unsaturated group;
(C) from about 0 to about 5 mass % of a compound having two or more ethylenically unsaturated group; and
(D) a polyol having a number average molecular weight of about 1500 or more.

Another aspect of the instant claim invention is a radiation curable resin composition comprising:

(A) a urethane (meth)acrylate which is a reaction product of a polyester polyol, a polyisocyanate, and a hydroxyl group-containing (meth)acrylate;
(B) a compound having a cyclic structure and one ethylenically unsaturated group;
(C) from about 0 to about 5 mass % of a compound having two or more ethylenically unsaturated group; and
(D) a polyol having a number average molecular weight of more than about 500 and less than about 1,500.

The third aspect of the instant claimed invention is a a process of making a coated electric wire comprising the steps of:

A) providing an electric wire;
B) providing a radiation curable resin composition, wherein said composition is the composition according to the first or second aspect of the instant claimed invention.
C) coating the electric wire with the radiation curable resin composition of the first or second aspect of the instant claimed invention;
D) applying radiation to the radiation curable resin composition to cure the radiation-radiation curable composition to become a solid layer.

The fourth aspect of the instant claimed invention is an electric wire coated with the composition of the first or second aspect of the instant claimed invention.

An electric wire-coating layer having excellent strength can be conveniently and uniformly formed by applying radiation such as ultraviolet rays to the composition of the present invention, and the protective layer can be removed by a simple operation. Therefore, these compositions have been found to have excellent peelability.

By using the composition of the instant claimed invention to coat wire a coated wire can be provided such that a wiring operation is facilitated, and the conductor is not damaged during the wiring operation.

### DETAILED DESCRIPTION OF THE INVENTION

The first aspect of the instant claimed invention is a radiation curable resin composition comprising:

(A) a urethane (meth)acrylate which is a reaction product of a polyol, a polyisocyanate, and a hydroxyl group-containing (meth)acrylate;
(B) a compound having a cyclic structure and one ethylenically unsaturated group;
(C) from about 0 to about 5 mass % of a compound having two or more ethylenically unsaturated group; and
(D) a polyol having a number average molecular weight of about 1500 or more.

The second aspect of the instant claimed invention is a radiation curable resin composition comprising:

(A) a urethane (meth)acrylate which is a reaction product of a polyester polyol, a polyisocyanate, and a hydroxyl group-containing (meth)acrylate;
(B) a compound having a cyclic structure and one ethylenically unsaturated group;
(C) from about 0 to about 5 mass % of a compound having two or more ethylenically unsaturated group; and
(D) a polyol having a number average molecular weight of more than about 500 and less than about 1,500.

In both of these aspects, component (A), (B), (C) are defined the same.

The first difference between the first and second aspect is that in the first aspect, Component (A) has a polyol that may be selected from many different types of polyol, including polyester polyols, but in the second aspect, Component (A) has a polyol that must be a polyester polyol.

The second difference between the first and second aspects of the instant claimed invention can be found in the number average molecular weight of the polyol used as component (D). Even though the chemistry of the polyols used as component (D) in the first and second aspect of the instant claimed invention can be identical, the number average molecular weight of component (D) in the first aspect is about 1500 or more and in the second aspect is more than about 50.0 and less than about 1500.

### Component (A)

The urethane (meth)acrylate used as the component (A) of the first and second aspects of the instant claimed invention is produced by reacting a polyol (this is not the polyol of Component (D)), a polyisocyanate, and a hydroxyl group-containing (meth)acrylate, for example. Specifically, the component (A) is produced by reacting isocyanate groups of the polyisocyanate with hydroxyl groups of the polyol and the hydroxyl group-containing (meth)acrylate. As the polyisocyanate, a diisocyanate is preferable.

The urethane (meth)acrylate used as the component (A) of the instant claimed invention is also produced by reacting isocyanate groups of the polyisocyanate with hydroxyl groups of the polyester polyol and the hydroxyl group-containing (meth)acrylate. As the polyisocyanate, a diisocyanate is preferable.

The component (A) may also be produced, by reacting 1 mol of the polyisocyanate (preferably) diisocyanate with 2 mol of the hydroxyl group-containing (meth)acrylate compound. Examples of such a urethane (meth)acrylate include a reaction product of hydroxyethyl(meth)acrylate and 2,4-tolylene diisocyanate, a reaction product of hydroxyethyl(meth)acrylate and 2,5 (or 2,6)-bis(isocyanatomethyl)-bicyclo[2.2.1]heptane, a reaction product of hydroxyethyl(meth)acrylate and isophorone diisocyanate, a reaction product of hydroxypropyl (meth)acrylate and 2,4-tolylene diisocyanate, and a reaction product of hydroxypropyl (meth)acrylate and isophorone diisocyanate.

The reaction method to make component (A), includes any or all of the following:

a) a method of reacting the polyol including polyester polyol, the polyisocyanate, and the hydroxyl group-containing (meth)acrylate all together;

b) a method of reacting the polyol, including polyester polyol with the polyisocyanate and reacting the resulting product with the hydroxyl group-containing (meth)acrylate;

c) a method of reacting the polyisocyanate with the hydroxyl group-containing (meth)acrylate and reacting the resulting product with the polyol, including polyester polyol;

d) a method of reacting the polyisocyanate with the hydroxyl group-containing (meth)acrylate, reacting the resulting product with the polyol, including polyester polyol, and reacting the resulting product with the hydroxyl group-containing (meth)acrylate; and any similar method.

Examples of the polyol that can be used to make component (A) are preferably a polyether polyol, a polyester polyol, a polycarbonate polyol, a polycaprolactone polyol, and the like. There are no specific limitations to the manner of polymerization of each structural unit of these polyols, which may be random polymerization, block polymerization, or graft polymerization.

Examples of the polyether polyol include polyethylene glycol, polypropylene glycol, polytetramethylene glycol, polyhexamethylene glycol, polyheptamethylene glycol, polydecamethylene glycol, aliphatic polyether polyols obtained by ring-opening copolymerization of two or more ion-polymerizable cyclic compounds, and the like. Examples of the ion-polymerizable cyclic compounds include cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epiehlorohydrin, glycidyl methacrylate, glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate. A polyether polyol obtained by ring-opening copolymerization of the above ion-polymerizable cyclic compound and a cyclic imine such as ethyleneimine, a cyclic lactonic acid such as β-propyolactone or lactide glycolic acid, or a dimethylcyclopolysiloxane may also be used. Examples of specific combinations of two or more ion-polymerizable cyclic compounds include tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like. The ring-opening copolymer of these ion-polymerizable cyclic compounds may be either a random copolymer or a block copolymer.

These aliphatic polyether polyols are commercially available as PTMG650, PTMG1000, PTMG2000 (manufactured by Mitsubishi Chemical Corp), PPG400, PPG1000, PPG2000, PPG3000, PPG4000, EXCENOL 720, 1020, 2020 (manufactured by Asahi Glass Urethane Co., Ltd.), PEG1000, Unisafe DC1100, DC1800 (manufactured by NOF Corporation), PPTG2000, PPTG1000, PTG400, PTGL2000 (manufactured by Hodogaya Chemical Co., Ltd.), Z-3001-4, Z-3001-5, PBG2000A, PBG2000B (manufactured by Daiichi Kogyo Seiyaku Co., Ltd.), and the like.

Examples of the polyether polyol include cyclic polyether polyols such as alkylene oxide addition polyol of bisphenol A, alkylene oxide addition polyol of bisphenol F, hydrogenated bisphenol A, hydrogenated bisphenol F, alkylene oxide addition polyol of hydrogenated bisphenol A, alkylene oxide addition polyol of hydrogenated bisphenol F, alkylene oxide addition polyol of hydroquinone, alkylene oxide addition polyol of naphthohydroquinone, alkylene oxide addition polyol of anthrahydroquinone, 1,4-cyclohexanepolyol and alkylene oxide addition polyol thereof, tricyclodecanepolyol, tricyclodecanedimethanol, pentacyclopentadecanepolyol, and pentacyclopentadecanedimethanol. Of these, alkylene oxide addition polyol of bisphenol A and tricyclodecanedimethanol are preferable. These polyols are commercially available as Uniol DA400, DA700, DA1000, DB400 (manufactured by NOF Corporation), tricyclodecanedimethanol (manufactured by Mitsubishi Chemical Corp.), and the like. Examples of the cyclic polyether polyol include alkylene oxide addition polyol of bisphenol A, alkylene oxide addition polyol of bisphenol F, alkylene oxide addition polyol of 1,4-cyclohexanepolyol, and the like.

Examples of the polyester polyol include a polyester polyol obtained by reacting a dihydric alcohol with a dibasic acid and the like. Examples of the dihydric alcohol include ethylene glycol, polyethylene glycol, propylene glycol, polypropylene glycol, tetramethylene glycol, polytetramethylene glycol, 1,6-hexanepolyol, neopentyl glycol, 1,4-cyclohexanedimethanol, 3-methyl-1,5-pentanepolyol, 1,9-nonanepolyol, 2-methyl-1,8-octanepolyol, and the like. Examples of the dibasic acid include phthalic acid, isophthalic acid, terephthalic acid, maleic acid, fumaric acid, adipic acid, sebacic acid, and the like. These polyester polyols are commercially available as Kurapol P-2010, PMIPA, PKA-A, PKA-A2, PNA-2000 (manufactured by Kuraray Co., Ltd.), and the like.

There are no specific limitations to the manner of polymerization of the structural units of the polyester polyols. Any of random polymerization, block polymerization, and graft polymerization may be employed.

Among these polyester polyols, those using an aromatic dicarboxylic acid such as phthalic acid, isophthalic acid, and terephthalic acid, and an alkane dicarboxylic acid such as adipic acid or sebacic acid, as a dibasic acid are preferable. The alkane moiety of the alkane dicarboxylic acid has carbon atoms preferably from 2 to 20, and particularly preferably from 2 to 14. A phenyl group is a preferable aromatic moiety of the aromatic carboxylic acid.

The number average molecular weight of the polyester polyol, used in Component (A) is preferably from about 400 to about 1,000, and more preferably from about 500 to about 800. The number average molecular weight is determined by gel permeation chromatography (GPC method) as a polystyrene-reduced molecular weight.

Examples of the polycarbonate polyol include polycarbonate of polytetrahydrofuran, polycarbonate of 1,6-hexanepolyol, and the like. As commercially available products of the polycarbonate polyol, DN-980, 981, 982, 983 (manufactured by Nippon Polyurethane Industry Co., Ltd.), PC-8000 (manufactured by PPG), PC-THF-CD (manufactured by BASF), and the like can be given.

Examples of the polycaprolactone polyol include polycaprolactonepolyol obtained by reacting ε-caprolactone with a dihydricpolyol such as ethylene glycol, polyethylene glycol, propylene glycol, polypropylene glycol, tetramethylene glycol, polytetramethylene glycol, 1,2-polybutylene glycol, 1,6-hexanepolyol, neopentyl glycol, 1,4-cyclohexanedimethanol, or 1,4-butanepolyol, and the like. These polyols are commercially available as PLACCEL 205, 205AL, 212, 212AL, 220, 220AL (manufactured by Daicel Chemical Industries, Ltd.), and the like.

Polyols other than those mentioned above may also be used. Examples of such polyols include ethylene glycol, propylene glycol, 1,4-butanepolyol, 1,5-pentanepolyol, 1,6-hexanepolyol, neopentyl glycol, 1,4-cyclohexanedimethanol, a dimethylol compound of dicyclopentadiene, tricyclodecanedimethanol, β-methyl-δ-valerolactone, hydroxy-terminated polybutadiene, hydroxy-terminated hydrogenated polybutadiene, castor oil-modified polyol, polyol-terminated compound of polydimethylsiloxane, polydimethylsiloxanecarbitol-modified polyol, and the like.

In addition to using the polyols in combination, a diamine may be used in combination with the polyol. Examples of the diamine include ethylenediamine, tetramethylenediamine, hexamethylenediamine, p-phenylenecliamine, 4,4′-diaminodiphenylmethane, diamines containing a hetero atom, polyether diamines, and the like.

If a polyether polyol is used, the aliphatic polyether polyol is preferable. Specifically, polypropylene glycol, and A copolymer of butene-1-oxide and ethylene oxide are preferable, with polypropylene glycol being particularly preferable. These polyols are commercially available as PPG400, PPG1000, PPG2000, PPG3000, EXCENOL 720, 1020, 2020 (manufactured by Asahi Glass Urethane Co., Ltd.), and the like. A diol which is a copolymer of butene-1-oxide and ethylene oxide is commercially available as EO/BO500, EO/BO1000, EO/BO2000, EO/BO3000, EO/BO4000 (manufactured by Daiichi Kogyo Seiyaku Co., Ltd.), and the like.

The number average molecular weight of the polyol used in the making of Component (A) is preferably from about 400 to about 1000, and more preferably from about 500 to about 800. The number average molecular weight is determined by gel permeation chromatography (GPC) using polystyrene as a standard.

Examples of the polyisocyanate (particularly diisocyanate) include 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexylisocyanate), 2,2,4-trimethylhexamethylene diisocyanate, bis(2-isocyanatoethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, 2,5 (or 2,6)-bis(isocyanatomethyl)-bicyclo[2.2.1]heptane, and the like. Of these, 2,4-tolylene diisocyanate, isophorone diisocyanate, xylylene diisocyanate, and methylenebis(4-cyclohexylisocyanate) are preferable.

These polyisocyanates may be used either individually or in combination of two or more.

Examples of the hydroxyl group-containing (meth)acrylate include 2-hydroxyethyl(meth)acrylate, 2-hydroxypropyl (meth)acrylate, 2-hydroxybutyl (meth)acrylate, 2-hydroxy-3-phenyloxypropyl (meth)acrylate, 1,4-butanediol mono(meth)acrylate, 2-hydroxyalkyl(meth)acryloyl phosphate, 4-hydroxycyclohexyl (meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, (meth)acrylates shown by the following formulas (1) and (2), and the like.

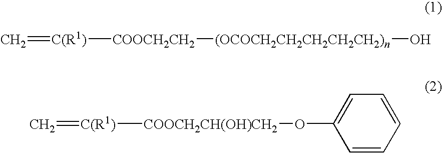

wherein R¹ represents a hydrogen atom or a methyl group, and n represents an integer from 1 to 15.

A compound obtained by the addition reaction of (meth)acrylic acid and a glycidyl group-containing compound such as an alkyl glycidyl ether, allyl glycidyl ether, or glycidyl (meth)acrylate may also be used. Of these hydroxyl group-containing (meth)acrylates, 2-hydroxyethyl (meth)acrylate, 2-hydroxypropyl (meth)acrylate, and the like are preferable.

These hydroxyl group-containing (meth)acrylate compounds may be used either individually or in combination of two or more.

The proportion of the polyol including polyester polyol, the polyisocyanate, and the hydroxyl group-containing (meth)acrylate is preferably determined so that the isocyanate groups included in the polyisocyanate and the hydroxyl groups included in the hydroxyl group-containing (meth)acrylate are respectively 1.1 to 3 equivalents and 0.2 to 1.5 equivalents for one equivalent of the hydroxyl groups included in the polyol, including polyester polyol.

When reacting these compounds, it is preferable to use a urethanization catalyst such as copper naphthenate, cobalt naphthenate, zinc naphthenate, di-n-butyltin dilaurate, triethylamine, 1,4-diazabicyclo[2.2.2]octane, or 2,6,7-trimethyl-1,4-diazabicyclo[2.2.2]octane in an amount of from about 0.01 to about 1 part by mass for 100 parts by mass of the reactants. The reaction temperature is preferably from about 10° C. to about 90° C., and particularly preferably from about 30° C. to about 80° C.

The hydroxyl group-containing (meth)acrylate may be partially replaced with a compound having a functional group which can be added to an isocyanate group. Examples of such a compound include γ-mercaptotrimethoxysilane, γ-aminotrimethoxysilane, and the like. Use of these compounds improves adhesion to a substrate such as glass.

To provide strength of the electric wire coating layer and the viscosity of the composition, the urethane (meth)acrylate used as the component (A) is added to the composition in an amount of usually from about 30 to about 80 mass %, preferably from about 40 to about 70 mass %, and particularly preferably from about 50 to about 70 mass % based on 100 mass % of the total amount of the components (A), (B), (C), and (D).

### Component (B)

The compound having a cyclic structure and one ethylenically unsaturated group used as the component (B) is a polymerizable monofunctional compound having a cyclic structure. The peelability of an electric wire-coating layer obtained using the composition of the present invention is improved by using the above compound as the component (B). Examples of the cyclic structure include an alicyclic structure, a heterocyclic structure including a nitrogen atom or an oxygen atom, an aromatic ring, and the like. Of these, an alicyclic structure is particularly preferable.

Examples of the monofunctional compound (B) having a cyclic structure include vinyl group-containing lactams such as N-vinylpyrrolidone and N-vinylcaprolactam, (meth)acrylates having an alicyclic structure such as isobornyl (meth)acrylate, bornyl (meth)acrylate, tricyclodecanyl (meth)acrylate, and dicyclopentanyl (meth)acrylate, benzyl (meth)acrylate, 4-butylcyclohexyl (meth)acrylate, acryloylmorpholine, vinylimidazole, vinylpyridine, and the like. Further examples include compounds shown by the following formulas (3) to (5).

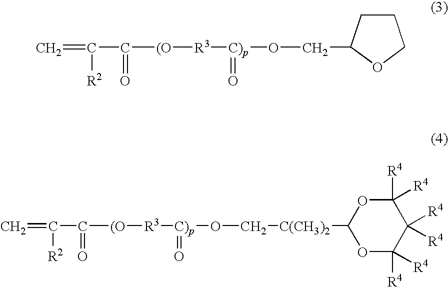

wherein R² represents a hydrogen atom or a methyl group, R³ represents an alkylene group having 2 to 8, and preferably 2 to 5 carbon atoms, R⁴ represents a hydrogen atom or a methyl group, and p represents an integer preferably from 1 to 4.

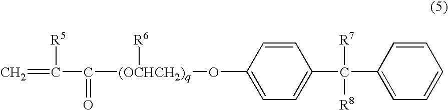

wherein R⁵, R⁶, R⁷, and R⁸ individually represent a hydrogen atom or a methyl group, and q represents an integer from 1 to 5.

Of these polymerizable monofunctional compounds (B), N-vinylpyrrolidone, vinyl group-containing lactams such as N-vinylcaprolactam, and isobornyl (meth)acrylate are preferable.

As commercially available products of these polymerizable monofunctional compounds (B), IBXA (manufactured by Osaka Organic Chemical Industry Co., Ltd.), Aronix M-111, M-113, M-114, M-117, TO-1210 (manufactured by Toagosei Co., Ltd.) can be given.

To provide the strength and peelability of the electric wire coating layer, the monofunctional compound having a cyclic structure used as the component (B) is added to the composition in an amount of

In one embodiment
at least about 10 mass %,
in another embodiment at least about 20 mass %; and
in one embodiment less than about 60 mass %,
in another embodiment less than about 50 mass %,
in yet another embodiment less than about 40 mass %
based on 100 mass % of the total amount of the components (A), (B), (C), and (D).

In a preferred embodiment of component (B), component (B) comprises isobornyl (meth)acrylate in an amount of 50 mass % or more of the component (B).

In another preferred embodiment of component (B), component (B) comprises isobornyl (meth)acrylate and an N-vinyl group-containing lactam compound.

In yet another preferred embodiment, of component (B), component (B) comprises isobornyl (meth)acrylate and an N-vinyl group-containing lactam compound wherein the N-vinyl group-containing lactam compound is N-vinylpyrrolidone.

In yet still another preferred embodiment, of component (B), component (B) comprises isobornyl (meth)acrylate and an N-vinyl group-containing lactam compound wherein the N-vinyl group-containing lactam compound is N-vinylcaprolactam.

### Component (C)

The compound (C) of the present invention is a polymerizable polyfunctional compound having two or more ethylenically unsaturated groups. The peelability of the electric wire-coating layer can be enhanced by adding a small amount of from about 0 mass % to about 10 mass %, that is, 10 mass % or less of this compound as the component (C) or without adding this compound.

Examples of the polymerizable polyfunctional compound (C) include trimethylolpropane tri(meth)acrylate, trimethylolpropanetrioxyethyl (meth)acrylate, pentaerythritol tri(meth)acrylate, triethylene glycol diacrylate, tetraethylene glycol di(meth)acrylate, tricyclodecanediyldimethanol diacrylate, 1,4-butanediol di(meth)acrylate, 1,6-hexanediol di(meth)acrylate, neopentyl glycol di(meth)acrylate, tripropylene glycol di(meth)acrylate, neopentyl glycol di(meth)acrylate, both terminal (meth)acrylic acid addition compound of bisphenol A diglycidyl ether, pentaerythritol tri(meth)acrylate, pentaerythritol tetra(meth)acrylate, polyester di(meth)acrylate, tris(2-hydroxyethyl)isocyanurate tri(meth)acrylate, tris(2-hydroxyethyl)isocyanurate di(meth)acrylate, tricyclodecanedimethanol di(meth)acrylate, di(meth)acrylate of ethylene oxide or propylene oxide addition diol of bisphenol A, di(meth)acrylate of ethylene oxide or propylene oxide addition diol of hydrogenated bisphenol A, epoxy(meth)acrylate in which (meth)acrylate is added to diglycidyl ether of bisphenol A, triethylene glycol divinyl ether, compounds shown by the following formula (6), and the like.

CH₂═C(R⁹)—COO—(CH₂—CH(R¹⁰)—O)ₙ—CO—C(R⁹)═CH₂ (6)

R⁹ and R¹⁰ individually represent a hydrogen atoms or a methyl group, and n is an integer from 1 to 100.

Of these polymerizable polyfunctional compounds, the compounds shown by the formula (6) such as ethylene glycol di(meth)acrylate, polyethylene glycol di(meth)acrylate, tricyclodecanediyldimethanol diacrylate, di(meth)acrylate of ethylene oxide addition product of bisphenol A, and tris(2-hydroxyethyl)isocyanurate tri(meth)acrylate, tripropylene glycol di(meth)acrylate are preferable, with tripropylene glycol di(meth)acrylate being particularly preferable.

As commercially available products of these polymerizable polyfunctional compounds, Yupimer UV, SA1002 (manufactured by Mitsubishi Chemical Corp.), Aronix M-215, M-315, M-325 (manufactured by Toagosei Co., Ltd.), and the like can be given. Aronix TO-1210 (manufactured by Toagosei Co., Ltd.) may also be used.

The compound (C) having two or more ethylenically unsaturated groups is added to the composition in an amount of from about 0 to about 10 mass %, preferably from about 0 to about 5 mass %, particularly preferably from about 0 to about 3 mass %, and most preferably about 0 mass % based on 100 mass % of the total amount of the components (A), (B), (C), and (D). It is important not to add more than about 10 mass because If the amount is more than about 10 mass %, the peelability of the electric wire-coating layer may be impaired.

### Component (D)

Component (D) is a polyol such as polyether polyol, polyester polyol, polycarbonate polyol, polycaprolactone polyol, and other polyols. There are no specific limitations to the manner of polymerization of the structural units of these polyols, which may be any of random polymerization, block polymerization, and graft polymerization.

In the first aspect of the instant claimed invention, Component (D) has an average molecular weight of about 1500 or more.

In the second aspect of the instant claimed invention, Component (D) has an average molecular weight of more than about 500 and less than about 1,500, especially when the urethane (meth)acrylate (A) of the radiation curable composition is a reaction product of a polyester polyol, a polyisocyanate and a hydroxyl group-containing (meth)acrylate.

Examples of the polyether polyol as component (D) are polyethylene glycol, polypropylene glycol, polytetramethylene glycol, polyhexamethylene glycol, polyheptamethylene glycol, polydecamethylene glycol, aliphatic polyether polyols obtained by ring-opening copolymerization of two or more ion-polymerizable cyclic compounds and the like. Examples of the ion-polymerizable cyclic compounds include cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate. A polyether polyol obtained by ring-opening copolymerization of the above ion-polymerizable cyclic compound and a cyclic imine such as ethyleneimine, a cyclic lactonic acid such as β-propyolactone or lactide glycolic acid, or a dimethylcyclopolysiloxane may also be used. As specific combinations of two or more ion-polymerizable cyclic compounds, tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of these ion-polymerizable cyclic compounds may be either a random copolymer or a block copolymer.

These aliphatic polyether polyols are commercially available PTMG2000 (manufactured by Mitsubishi Chemical Corp.), PPG2000, PPG3000, EXCENOL 2020 (manufactured by Asahi Glass Urethane Co., Ltd.), DC1800 (manufactured by Nippon Oil and Fats Co., Ltd.), PPTG2000, PTGL2000 (manufactured by Hodogaya Chemical Co., Ltd.), PBG2000A, PBG2000B (manufactured by Daiichi Kogyo Seiyaku Co., Ltd.), and the like.

Examples of the polyether polyol include cyclic polyether polyols such as alkylene oxide addition polyol of bisphenol A, alkylene oxide addition polyol of bisphenol F, hydrogenated bisphenol A, hydrogenated bisphenol F, alkylene oxide addition polyol of hydrogenated bisphenol A, alkylene oxide addition polyol of hydrogenated bisphenol F, alkylene oxide addition polyol of hydroquinone, alkylene oxide addition polyol of naphthohydroquinone, alkylene oxide addition polyol of anthrahydroquinone, 1,4-cyclohexanepolyol and alkylene oxide addition polyol thereof, tricyclodecanepolyol, tricyclodecanedimethanol, pentacyclopentadecanepolyol, and pentacyclopentadecanedimethanol. As examples of the cyclic polyether polyol, alkylene oxide addition polyol of bisphenol A, alkylene oxide addition polyol of bisphenol F, alkylene oxide addition polyol of 1,4-cyclohexanepolyol, and the like can be given. These polyols may be a linear molecule or may have a branched structure. A linear molecule and a branched structure may be present in combination.

It is preferable that the composition include a polyol which has a branched structure such as an alkyl group represented by a methyl group or an ethyl group, includes a hydroxyl group at the terminal of each branched chain, and has a value obtained by dividing the molecular weight of the polyol by the number of hydroxyl groups at the branched chain terminals of 500 to 2000 (hereinafter called “polyol having a branched structure”).

As specific examples of the polyol having a branched structure, polyols obtained by ring-opening polymerization of glycerol, sorbitol, or the like and at least one compound selected from ethylene oxide, propylene oxide, and butylene oxide are preferable, with polypropylene glycol and a copolymer of butene-1-oxide and ethylene oxide being particularly preferable.

In the first aspect of the instant claimed invention the number average molecular weight of the polyol is about from about 1500 or more. The number average number molecular weight of the polyol is preferably from about 1500 to about 12000, more preferably from about 2000 to about 10,000, and particularly preferably from about 2500 to about 8000 as a polystyrene-reduced molecular weight determined by gel permeation chromatography.

In the second aspect of the instant claimed invention the number average molecular weight of the polyol is more than about 500 and less than about 1500.

The polyol having a branched structure preferably has three to six branched-chain-terminal hydroxyl groups in the molecule.

These polyols are commercially available as PPG2000, PPG3000, EXCENOL 2020 (manufactured by Asahi Glass Urethane Co., Ltd.), and the like. The copolymer diol of butene-1-oxide and ethylene oxide is commercially available as EO/BO2000, EO/BO3000, EO/BO4000 (manufactured by Daiichi Kogyo Seiyaku Co., Ltd.), and the like.

As commercially available products of the polyol having a branched structure, Sunnixi TP-400, Sunnix GL-3000, Sunnix GP-250, Sunnix GP-400, Sunnix GP-600, Sunnix GP-1000, Sunnix GP-3000, Sunnix GP-3700M, Sunnix GP-4000, Sunnix GEP-2800, Newpol TL4500N (manufactured by Daiichi Kogyo Seiyaku Co., Ltd., Asahi Glass Urethane Co., Ltd., and Sanyo Chemical Industries, Ltd.), and the like can be given.

The component (D) is added to the composition in an amount of preferably from about 1 to about 30 mass %, more preferably from about 5 to about 25 mass %, and particularly preferably about 5 to about 20 mass % based on 100 mass % of the total amount of the components (A), (B), (C), and (D,) from the viewpoint of the peelability and strength of the electric wire-coating layer.

### Component (E)

It is preferable that the composition of the present invention further comprises (E) a silicone compound from the viewpoint of the peelability and weatherability of the electric wire-coating layer. As examples of the silicone compound, polyether-modified silicone, alkyl-modified silicone, urethane acrylate-modified silicone, urethane-modified silicone, methylstyryl-modified silicone, epoxy polyether-modified silicone, alkylaralkyl polyether-modified silicone, and the like can be given. Of these, polyether-modified silicone is particularly preferable. As the polyether-modified silicone, a polydimethylsiloxane compound in which at least one silicon atom is bonded to a group R¹⁴—(R¹⁵O)ₛ—R¹⁶— (wherein R¹⁴ represents a hydroxyl group or an alkoxy group having 1 to 10 carbon atoms, R¹⁵ represents an alkylene group having 2 to 4 carbon atoms (R¹⁵ may contain two or more alkylene groups), R¹⁶ represents an alkylene group having 2 to 12 carbon atoms, and s represents an integer from 1 to 20) is preferable. As R¹⁵, an ethylene group and a propylene group are preferable, with an ethylene group being particularly preferable.

As commercially available products of the silicone compound which does not include a polymerizable group such as an ethylenically unsaturated group, SH28PA (manufactured by Dow Corning Toray Silicone Co., Ltd., dimethylpolysiloxane-polyoxyalkylene copolymer), Pantad 19, 54 (manufactured by Dow Corning Toray Silicone Co., Ltd., dimethylpolysiloxane-polyoxyalkylene copolymer), Silaplane FM0411 (manufactured by Chisso Corp.), SF8428 (manufactured by Dow Corning Toray Silicone Co., Ltd., dimethylpolysiloxane-polyoxyalkylene copolymer (including side chain OH)), BYKUV3510 (manufactured by BYK-Chemie Japan, dimethylpolysiloxane-polyoxyalkylene copolymer), DC57 (manufactured by Dow Corning Toray Silicone Co., Ltd., dimethylpolysiloxane-polyoxyalkylene copolymer), and the like can be given. As the commercially available products of the silicone compound which includes a polymerizable group such as an ethylenically unsaturated group, TegoRad 2300, 2200N (manufactured by Tego Chemie Service (Degussa Japan Co., Ltd.)) can be given.

The average molecular weight of the silicone compound (E) is preferably from about 1500 to about 35,000 from the viewpoint of the peelability of the electric win-coating layer. The average molecular weight of the silicone compound is more preferably from about 1500 to about 20,000, still more preferably from about 1500 to about 20,000, and particularly preferably from about 3000 to about 15,000.

It is preferable that the component (E) does not include a polymerizable group such as an ethylenically unsaturated group. If the component (E) does not include a polymerizable group, excellent peelability can be maintained.

The component (E), if present, is added to the composition in an amount of preferably from about 0.1 to about 50 mass %, more preferably from about 0.5 to about 40 mass %, and particularly preferably from about 1 to about 20 mass % based on 100 mass % of the total amount of the components (A), (B), (C), and (D) from the viewpoint of the peelability and strength of the electric wire-coating layer.

### Component (F)

The composition of the present invention may further comprise (F) a polymerization initiator. As the polymerization initiator, a photoinitiator may be used. As examples of the photoinitiator, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl methyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide; IRGACURE 184, 369, 651, 500, 907, CGI 1700, CGI 1750, CGI 1850, CG24-61, Darocur 1116, 1173 (manufactured by Ciba Specialty Chemicals Co.); Lucirin TPO (manufactured by BASF); Ubecryl P36 (manufactured by UCB); and the like can be given. As examples of the photosensitizer, triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate; Ubecryl P102, 103, 104, 105 (manufactured by UCB); and the like can be given.

The polymerization initiator (F) is added to the composition in an amount of preferably from about 0.1 to about 10 mass %, and particularly preferably from about 0.3 to about 7 mass % based on 100 mass % of the total amount of the components (A), (B), (C), and (D).

Various additives such as antioxidants, coloring agents, UV absorbers, light stabilizers, heat polymerization inhibitors, leveling agents, surfactants, preservatives, plasticizers, lubricants, solvents, fillers, aging preventives, wettability improvers, and coating surface improvers may be optionally added to the composition of the present invention insofar as the characteristics of the present invention are not adversely affected.

The fourth aspect of the instant claimed invention is an electric wire coated with the composition of the first or second aspect of the instant claimed invention.

The third aspect of the instant claimed invention is a process of making a coated electric wire comprising the steps of:

A) providing an electric wire;
B) providing a radiation curable resin composition, wherein said composition is the composition according to the first or second aspect of the instant claimed invention.
C) coating the electric wire with the radiation curable resin composition of the first or second aspect of the instant claimed invention;
D) applying radiation to the radiation curable resin composition to cure the radiation-radiation curable composition to become solid layer.

Electric wires are commercially available as is the equipment to cat them with protective coatings.

Once applied to an electric wire, the composition of the present invention may be cured by applying radiation. The term “radiation” used herein includes infrared light, visible light, ultraviolet light, X-rays, electron beams, α-rays, β-rays, γ-rays, and the like.

The fourth aspect of the instant claimed invention is an electric wire coated with the composition of the first or second aspect of the instant claimed invention.

The composition of the present invention is useful as a radiation curable resin composition for coating at electric wire, particularly a relatively thin electric wire and cable such as a telephone table and an automotive electric wire. The composition is useful to coat a sheath layer provided in contact with the exterior of a shield wire of an electric wire having a center conductor and a shield wire. A uniform electric wire-coating layer having excellent strength can be easily formed by applying the composition of the present invention and applying radiation (e.g., ultraviolet rays) to the composition. Since the electric wire-coating layer formed according to the present invention has excellent strength and good peelability, excellent wiring operability is achieved.

### EXAMPLES

The present invention will be described in more detail by way of examples, which should not be construed as limiting the present invention.

### 1. Preparation Example 1

### Synthesis 1 of urethane (meth)acrylate (UA-1)

A reaction vessel equipped with a stirrer was charged with 0.240 g of 2,6-di-t-butyl-p-cresol, 271.72 g of 2,4-tolylene diisocyanate, and 546.07 g of polypropylene glycol with a number average molecular weight of 700. The mixture was then cooled to 15° C. After the addition of 0.799 g of dibutyltin 1.0 dilaurate, the mixture was stirred for one hour while controlling the liquid temperature at less than 40° C. The mixture was cooled with ice to 15° C. or less with stirring. After the dropwise addition of 181.17 g of hydroxyethyl acrylate while controlling the liquid temperature at 20° C. or less, the mixture was allowed to react for one hour with stirring. The mixture was then stirred at 70 to 75° C. for three hours. The reaction was terminated when the residual isocyanate content became 0.1 mass % or less. The resulting urethane (meth)acrylate (A) is referred to as “UA-1”.

### Examples 1 to 3 and Comparative Examples 1 and 2

### Not Examples of the Instant Claimed Invention

A reaction vessel equipped with a stirrer was charged with the components listed in Table 1. The mixture was then stirred for one hour while controlling the liquid temperature at 50° C. to obtain a curable liquid resin composition.

### 2. Preparation Example 1p

### Synthesis 1 of urethane (meth)acrylate (UA-1p)

A reaction vessel equipped with a stirrer was charged with 0.120 g of 2,6-di-t-butyl-p-cresol, 233.12 g of isobornyl acrylate, and 62.99 g of toluene diisocyanate. The mixture was cooled to 15° C. while stirring. After the addition of 42.00 g of hydroxyethyl acrylate dropwise while controlling the temperature at 20° C. or less, the mixture was stirred at 40° C. on a water bath for one hour. Then, 380.67 g of a dialchohol (a polyester diol) was added and the mixture was stirred at 70° C. for three hours. The reaction was terminated when the remaining isocyanate reduced to 0.1 mass % or less. The resulting urethane (meth)acrylate (A) is referred to as “UA-1p”.

### 3. Preparation Example 2p

### Synthesis 2 of urethane (meth)acrylate (UA-2p)

Urethane (meth)acrylate (A2p) was prepared in the same manner as in Preparation Example 1 except for using isophorone diisocyanate instead of 2,4-tolylene diisocyanate in the same amount of the 2,4-tolylene diisocyanate. The resulting urethane (meth)acrylate is referred to as “UA-2p”.

### Examples 1p-3p and Comparative Example 4p

A reaction vessel equipped with a stirrer was charged with the components listed in Table 2. The mixture was stirred for one hour while controlling the liquid temperature at 50° C. to obtain curable liquid resin compositions.

### 4. Preparation of Example 1q

### Synthesis of urethane (meth)acrylate (UA-1g)

A reaction vessel equipped with a stirrer was charged with 0.120 g of 2,6-di-t-butyl-p-cresol, 233.12 g of isobornyl acrylate and 62.99 g of tolylene diisocyanate. The mixture was cooled down to 15° C. while stirring. After the addition of 42.00 g of hydroxyethyl acrylate dropwise while controlling the temperature at 20° C. or less, the mixture was stirred at 40° C. on a water bath for one hour. After that, 380.67 g of a polyester diol having a number average molecular weight of 2000 (poly[(3-methyl-1,5-pentandiol)—alternatively—(isophtalic acid): P-2030, Cray Manufacturer]) was added and the mixture was stirred at 70° C. for three hours. The reaction was terminated when the remaining isocyanate reduced to 0.1 mass % or less. The resulting urethane (meth)acrylate (A) is referred to as “UA-1q”.

### 5. Preparation of Example 2q

### Synthesis of urethane (meth)acrylate (UA-2q)

A reaction vessel equipped with a stirrer was charged with 36.909 g of a polypropylene glycol having a number average molecular weight of 700, 18.366 g of 2,4-tolylene diisocyanate, 0.016 g of 2,6-di-t-butyl-p-cresol. The mixture was cooled down to 15° C. while stirring. Then 0.054 g of di-tertbutyl tin dilaurate was added. After the liquid temperature raise was no longer detected, the reaction was run for 1 hour at 35° C. After 12.245 g of 2-hydroxy ethyl acrylate was added and was stirred so that the liquid temperature did not exceed 50° C., the reaction was continued for 2 hours at 65° C. to 70° C. while stirring. The reaction was terminated when the remaining isocyanate reduced to 0.1 mass % or less. The resulting urethane (meth)acrylate (A) is referred to as “UA-2q”.

### Examples 1q-4q and Comparative Example 5q

A reaction vessel equipped with a stirrer was charged with the components listed in Table 3. The mixture was stirred for one hour while controlling the liquid temperature at 50° C. to obtain curable liquid resin compositions.

### Test Example

The curable liquid resin compositions obtained in the above examples and comparative examples were cured using the following method to prepare specimens. The specimens were evaluated as follows. The results are shown in Table 1 and Table 2 and Table 3.

### 1. Young's Modulus

The curable liquid resin composition was applied to a glass plate using an applicator bar with a gap size of 250 μm, and was cured by applying ultraviolet rays at a dose of 1 J/cm² in air to obtain a film for measuring the Young's modulus. The film was cut into a strip-shaped sample with a width of 6 mm and a length of 25 mm (portion to be pulled). The sample was subjected to a tensile test at a temperature of 23° C. and a humidity of 50%. The Young's modulus was calculated from the tensile strength at a strain of 2.5% and a tensile rate of 1 mm/min.

### 2. Breaking Strength and Elongation at Break

The breaking strength and the elongation at break of the specimen were measured using a tensile tester (“AGS-50G” manufactured by Shimadzu Corp.).

Tensile rate: 50 mm/min
Benchmark distance (measurement distance): 25 mm
Measurement temperature: 23° C.
Relative humidity: 50% RH

### 3. Peelability (Adhesion Force)

The peelability (adhesion force) of the cured products of the compositions obtained in Examples and Comparative Examples was evaluated. The liquid composition was applied to a glass plate using an applicator with a gap size of 125 μm. The applied liquid composition was irradiated with ultraviolet rays at a dose of 0.1 J/cm² in a 5% oxygen atmosphere to obtain a cured film with a thickness of about 70 μm. The surfaces of the cured film were bonded. The cured film was placed between glass plates and allowed to stand at a temperature of 23° C. and humidity of 50% for 24 hours. A sample in the shape of a strip having a pulling portion with a width of 10 mm was prepared from the cured film. An adhesion test of the sample was carried out according to JIS Z0237 using a tensile tester. The adhesion was calculated from the tensile strength at a tensile rate of 50 mm/min.

### 4. Peelability (Adhesion to Copper Sheet)

The adhesion of the cured products of the compositions obtained in Examples and Comparative Examples was evaluated. The liquid composition was applied to a copper sheet using an applicator with a gap size of 190 μm. The applied liquid composition was irradiated with ultraviolet rays at a dose of 0.1 J/cm² in a nitrogen atmosphere to obtain a cured film with a thickness of about 130 μm. The sample was allowed to stand at a temperature of 23° C. and a humidity of 50% for 24 hours. A sample in the shape of a strip with a width of 10 mm was prepared on the copper sheet from the cured film. An adhesion test of the sample was carried out according to JIS Z0237 using a tensile tester. The adhesion to a metal was calculated from the tensile strength at a tensile rate of 50 mm/min.

TABLE 1

| | Ingredient with | | | | | |
|---|---|---|---|---|---|---|
| | amount of | | | | | |
| | ingredient given | | | | Comparative | Comparative |
| | as part by mass | Example 1 | Example 2 | Example 3 | Example 1 | Example 2 |
| (A) | UA-1 | 62.0 | 61.0 | 54 | 58.0 | 72.0 |
| (B) | Isoborbyl | 20.0 | 20.0 | 20.0 | — | 20.0 |
| | acrylate | | | | | |
| | N- | 8.0 | 9.0 | 16 | — | 8.0 |
| | Vinylcaprolactam | | | | | |
| (C) | 2-Ethylhexyl | — | — | — | 39.0 | — |
| | acrylate | | | | | |
| (D) | PPG 4000 | 10.0 | 20.0 | 10.0 | 30.0 | — |
| (E) | SH28PA | 2.0 | 2.0 | 2.0 | 2.0 | 2.0 |
| (F) | Lucirin TPO | 0.9 | 0.9 | 0.9 | 0.9 | 0.9 |
| | Irgacure 184 | 2.0 | 2.0 | 2.0 | 2.0 | 2.0 |
| | Irganox 245 | 0.3 | 0.3 | 0.3 | 0.5 | 0.3 |
| | Total | 105.2 | 115.2 | 105.2 | 129.5 | 105.2 |
| | TEST METHOD [symbol] | | | | | |
| | Young's modulus | 86 | 78 | 363 | 96 | 120 |
| | (MPa) | | | | | |
| | Breaking | 25 | 23 | 30 | 12 | 25 |
| | strength (MPa) | | | | | |
| | Elongation at | 100 | 94 | 129 | 27 | 98 |
| | break (MPa) | | | | | |
| | Adhesion (N/cm²) | 0.8 | 0.7 | 0.7 | 0.8 | 5.8 |
| | Adhesion to | 1.4 | 0.7 | 1.6 | 1.4 | 5.9 |
| | copper sheet | | | | | |
| | (N/cm²) | | | | | |

PPG 4000: polypropylene glycol having a molecular weight of 4000 (manufactured by Asahi Glass Urethane Co., Ltd.)
SH28PA: dimethylpolysiloxane-polyoxyalkylene copolymer (manufactured by Dow Corning Toray Silicone Co., Ltd.)
Irgacure 184: 1-hydroxycyclohexyl phenyl ketone (manufactured by Ciba Specialty Chemicals Co., Ltd.)
Lucirin TPO: 2,4,6-Trimethylbenzoyldiphenylphosphine oxide (manufactured by Ciba Specialty Chemicals Co., Ltd.)
Irganox 245: ethylenebis(oxyethylene)bis[3-(5-t-butyl-4-hydroxy-m-tolyl)propionate] (manufactured by Ciba Specialty Chemicals Co., Ltd.)

As is clear from the results as described in Table 1, the cured product of the composition of the present invention containing the compounds (A), (B), (C), and (D) exhibit excellent properties as a wire coating material band has excellent peelability. Therefore, the composition of the present invention is useful as an electric wire coating composition.

TABLE 2

| | | | | | Comparative |
|---|---|---|---|---|---|
| | | | | | Example (not |
| Ingredient with | | | | | an example of |
| amount of ingredient | | Example | | | the invention) |
| given as part by mass | | 1p | 2p | 3p | 4p |
| (A) | UA-1p | 46.00 | 50.00 | 50.00 | — |
| | UA-2p | — | — | — | 54 |
| (B) | Isobornyl acrylate | 20.00 | 24.00 | 24.00 | 20.00 |
| | N-vinylcaprolactam | 24.00 | 16.00 | 16.00 | 16.00 |
| (D) | PPG 4000 | — | — | — | 10.00 |
| | PPG 1000 | 10.00 | 8.0 | 10.00 | — |
| (E) | SH28PA | 1.00 | 1.00 | 1.00 | 2.00 |
| (F) | Irgacure 184 | 3.00 | 3.00 | 3.00 | 2.00 |
| | Irganox 245 | — | — | — | 0.9 |
| | Totals | 104.50 | 102.50 | 104.50 | 105.20 |
| | Test Method [symbol] | | | | |
| | Viscosity (Pa · s) | 3.7 | 8.7 | 8.4 | 1.8 |
| | 25° C. | | | | |
| | Young's modulus | 130 | 120 | 71 | 380 |
| | (MPa) | | | | |
| | Breaking strength | 30 | 22 | 21 | 30 |
| | (MPa) | | | | |
| | Breaking | 148 | 140 | 150 | 129 |
| | elongation (%) | | | | |
| | Adhesion force (N/m) | 1.0 | 1.1 | 0.8 | 2.4 |
| | Adhesion force with | 0.9 | 0.9 | 0.7 | 2.0 |
| | copper plate (N/m) | | | | |

In Table 2
“SH28PA”: dimethylpolysiloxane-polyoxyalkylene copolymer (manufactured by Dow Corning Toray Co., Ltd.)
“PPG 4000”: polypropylene glycol with a molecular weight 4,000 (manufactured by Asahi Glass Urethane Co., Ltd.)
“PPG 1000”: polypropylene glycol with a molecular weight 1,000 (manufactured by Asahi Glass Urethane Co., Ltd.)
“Irgacure 184”: 1-hydroxycyclohexyl phenyl ketone (manufactured by Ciba Specialty Chemicals Co., Ltd.)
“Irganox 245”: ethylenebis(oxyethylene)bis-[3-(5-tert-butyl-4-hydroxy-m-tolyl)propionate] (manufactured by Ciba Specialty Chemicals Co., Ltd.)

As is clear from Table 2, the cured product made from the resin composition of the present invention containing the components (A), (B), (C (not present in these examples)), and (D) possesses excellent properties as an electric wire coating material and exhibits excellent peelability. Therefore, the composition is useful as a composition for electric wire coating.

TABLE 3

| | | | | | Comparative |
|---|---|---|---|---|---|
| | | | | | Example (not |
| Ingredient with amount of | | | | | an example of |
| ingredient given as part | Example | | | | the invention) |
| by mass | 1q | 2q | 3q | 4q | 5q |

| | | | | | | |
|---|---|---|---|---|---|---|
| (A) | UA-1q | 46.00 | 50.00 | 50.00 | 50.00 | — |
| (B) | Isobornyl acrylate | 20.00 | 24.00 | 24.00 | 24.00 | 20.00 |
| | N-vinylpyrrolidone | 24.00 | 16.00 | 16.00 | 16.00 | 16.00 |
| (D) | PPG 4000 | — | — | — | — | 10.00 |
| | PPG 1000 | 10.00 | 8.0 | 10.00 | 7.0 | — |
| (E) | SH28PA | 1.00 | 1.00 | 1.00 | — | 2.00 |
| | SF8411 | — | — | — | 2.0 | — |
| (F) | Irgacure 184 | 3.00 | 3.00 | 3.00 | 2.0 | 2.00 |
| | Lucirin TPO | — | — | — | 0.9 | — |
| | UA-2q | — | — | — | — | 54.0 |
| | Irganox 245 | — | — | — | — | 0.9 |
| | Total | 104.50 | 102.50 | 104.50 | 100.5 | 104.9 |
| | Test Method [symbol] | | | | | |
| | Viscosity (Pa · s) 25° C. | 3.7 | 8.7 | 8.4 | 9.5 | 1.8 |
| | Young's modulus (MPa) | 130 | 120 | 71 | 230 | 380 |
| | Breaking strength (MPa) | 30 | 22 | 21 | 31 | 30 |
| | Breaking elongation (%) | 148 | 140 | 150 | 180 | 129 |
| | Adhesion force (N/m) | 1.0 | 1.1 | 0.8 | 1.3 | 2.4 |
| | Adhesion force with | 0.9 | 0.9 | 0.7 | 1.1 | 2.0 |
| | copper plate (N/m) | | | | | |

In Table 3,
“SH28PA”: dimethylpolysiloxane-polyoxyalkylene copolymer (manufactured by Dow Corning Toray Co., Ltd.)
“SF8411”: epoxy-modified silicone (manufactured by Toray-Dow Corning)
“PPG 4000”: polypropylene glycol with a molecular weight 4,000 (manufactured by Asahi Glass Urethane Co., Ltd.)
“PPG 1000”: polypropylene glycol with a molecular weight 1,000 (manufactured by Asahi Glass Urethane Co., Ltd.)
“Irgacure 184”: 1-hydroxycyclohexyl phenyl ketone (manufactured by Ciba Specialty Chemicals Co., Ltd.)
“Lucirin TPO”: (2,4,6-trimethylbenzoyl)diphenylphosphine oxide
“Irganox 245”: ethylenebis(oxyethylene)bis-[3-(5-tert-butyl-4-hydroxy-m-tolyl)propionate] (manufactured by Ciba Specialty Chemicals Co., Ltd.)

As is clear from Table 3, the cured product made from the resin composition of the present invention containing the components (A), (B), (C (not present in these examples)), and (D) possesses excellent properties as an electric wire coating material and exhibits excellent peelability. Therefore, the composition is useful as a composition for electric wire coating.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A radiation curable resin composition comprising:
(A) a urethane .(meth)acrylate which is a reaction product of a polyol, a polyisocyanate, and a hydroxyl group-containing (meth)acrylate;
(B) a compound having a cyclic structure and one ethylenically unsaturated group;
(C) from about 0 to about 5 mass % of a compound having two or more ethylenically unsaturated group; and
(D) a polyol having a number average molecular weight of about 1500 or more.

2. A radiation curable resin composition comprising:
(A) a urethane (meth)acrylate which is a reaction product of a polyester polyol, a polyisocyanate, and a hydroxyl group-containing (meth)acrylate;
(B) a compound having a cyclic structure and one ethylenically unsaturated group;
(C) from about 0 to about 5 mass % of a compound having two or more ethylenically unsaturated group; and
(D) a polyol having a number average molecular weight of more than about 500 and less than about 1,500.

3. The composition according to claim 2, wherein the component (A) is a urethane (meth)acrylate which is a reaction product of a polyester polyol, a polyisocyanate, and a hydroxyl group-containing (meth)acrylate having an aromatic structure.

4. The composition according to claim 1, wherein the component (B) comprises isobornyl (meth)acrylate in an amount of 50 mass % or more of the component (B).

5. The composition according to claim 1, wherein the component (B) comprises isobornyl (meth)acrylate and an N-vinyl group-containing lactam compound.

6. The composition according to claim 5, wherein the N-vinyl group-containing lactam compound is N-vinylpyrrolidone.

7. The composition according to claim 5, wherein the N-vinyl group-containing lactam compound is N-vinylcaprolactam.

8. The composition according to claim 1, further comprising (E) a silicone compound.

9. The composition according to claim 1, wherein said composition is used to coat an electric wire.

10. The composition according to claim 1, wherein said composition is used to coat a sheath layer provided in contact with the exterior of a shield wire of an electric wire having a center conductor and a shield wire.

11. An electric wire coating layer produced by curing the composition according to claim 1.

12. An electrical wire comprising the coating layer according to claim 11.

13. A process of making a coated electric wire comprising the steps of:
A) providing an electric wire;
B) providing a radiation curable resin composition, wherein said composition is the composition according to claim 1; C) coating the electric wire with the radiation curable resin composition;
D) applying radiation to the radiation curable resin composition to cure the radiation-radiation curable composition to become a solid layer.
